(19) United States
(12) Patent Application Publication
(10) Pub. No.: US 2026/0148921 A1
(43) Pub. Date: May 28, 2026

(54) CONTACTOR DESIGN CONFIGURATION WITH IMPROVED SHORT CIRCUIT AND SWITCH-OFF CAPABILITIES

(71) Applicant: TE Connectivity Solutions GmbH, Schaffhausen (CH)

(72) Inventors: Hugo FONTES, Schaffhausen (CH); António Perdigão DUARTE SILVA, Schaffhausen (CH); Tiago TEIXEIRA, Schaffhausen (CH); Vitor MOREIRA, Schaffhausen (CH); Nuno LEAL, Schaffhausen (CH); Joao M. PINHEIRO, Schaffhausen (CH); Joaquim PEREIRA, Schaffhausen (CH)

(21) Appl. No.: 19/401,508

(22) Filed: Nov. 26, 2025

(30) Foreign Application Priority Data
Nov. 28, 2024 (EP) 24398028.1

(51) Int. Cl. H01H 50/44; H01H 50/14; H01H 50/54

(52) U.S. Cl. CPC H01H 50/44; H01H 50/14; H01H 50/54; H01H 2235/01

(57) ABSTRACT

A contact system and an electromagnetic contactor include a movable contact that moves along a closing direction and a pair of stationary contacts disposed facing each other along a longitudinal direction transverse to the closing direction. Each of the stationary contacts has a C-shaped body with a first leg and a second leg oriented towards a center of the contact system and spaced apart along the closing direction. The movable contact has a first movable contact section disposed between the first and the second legs of the first stationary contact and a second movable contact section disposed between the first and the second legs of the second stationary contact. The first and the second stationary contacts each include a terminal section extending from the respective second leg towards a direction that forms a non-zero angle with the longitudinal direction.

### CROSS REFERENCE TO RELATED APPLICATIONS

This application claims the benefit of EP Application No. 2439828.1, filed 28 Nov. 2024, the subject matter of which is herein incorporated by reference in its entirety.

### BACKGROUND OF THE INVENTION

The subject matter herein relates to contactor mechanisms based on fixed and movable contacts which are operable for interrupting a circuit path in events such as a high current discharge and short-circuits. More specifically, the subject matter herein relates to contactor mechanisms having a design of fixed and movable contacts which leads to a leverage of the repulsive Holm forces generated between the contacts when the contactor mechanism is disconnected at high currents, and to electromagnetic contactors comprising the contactor mechanisms.

Electromagnetic switching devices, such as contactors and relays, are commonly used for protecting high-voltage circuits and power equipment against overload and/or high-current discharges in a wide range of applications, such as in industrial plants and in the electric automobile industry (for e.g. in batteries).

The continued demand for power devices capable of operating at increasingly high-voltages, namely, in the electric automobile industry, led to a need for high-voltage contactors having high short-circuit resistance that can endure high currents of up to 21.8 kA without the risk of exploding or generating flames. There is also a demand for contactors having high switch-off capabilities, for e.g. at currents surpassing 2500 A for a load voltage of 1000 V. Furthermore, the size limitations imposed by certain applications, such as electrical boxes (E-box) for electric vehicles, require contactor designs capable of operating reliably under the high-current and high-voltage requirements mentioned above while occupying the smallest volume possible.

Conventional contactor mechanisms include at least one stationary contact, which is fixed to the contactor body, and a movable contact which is kept in pressed against the opposed stationary contact under the actuation of a contact force. This contact force is conventionally generated under the actuation of an electromagnetic driving system, often an energized electromagnetic coil coupled to a movable magnetic core, which maintains the contactor mechanism closed under normal operating conditions. In the event of a short-circuit or a high current discharge across the contactor mechanism, the electromagnetic driving system is de-energized and the contactor mechanism opens.

A common drawback of such conventional contactors lies in that strong repulsive forces (commonly referred to as Holm forces) are generated at the contact points between the stationary and movable contacts when the contactor mechanism interrupts a very high current. These Holm forces, which are associated with the real contact points between fixed and movable contacts being in general lower than the apparent area of contact, tend to pull the movable and fixed contacts apart, thereby counter-acting the contact force that keeps the contactor closed under normal operating conditions. The strength of the repulsive Holm forces increases with the current intensity across the closed contactor and may become very strong at current discharges of 15 kA and above, leading to several undesirable effects. For instance, the contactor mechanism may inadvertently open at currents lower than desired due to the repulsive Holm forces reducing the contact force that keeps the contactor mechanism closed. Moreover, when a high-current is interrupted due to a short-circuit event the repulsive Holm forces may become so strong that the speed at which the movable and stationary contacts open is significantly increased, resulting in the contacts being strongly pulled apart. This effect may destroy the contactor mechanism which will become inoperable for future use.

The adverse effects of the repulsive Holms forces may be minimized by increasing the contact force, for e.g. by increasing the actuation force generated by the electromagnetic driving system. However, this is not a viable solution for many applications, namely, those requiring contactors of a reduced size, since the increase of the contact force requires the use of larger magnetic coils and/or the supply of higher energizing currents.

Several contactor mechanisms have been proposed for mitigating the adverse effects associated with the repulsive Holm forces.

For instance, U.S. Pat. No. 8,816,801 B2 proposes a contact mechanism where the fixed contactor is set to a L- or a C-shape for generating a Lorentz force capable of resisting the electromagnetic repulsion in the contactor opening direction when a current traverses the contact mechanism. However, this design poses a new problem in that the extinction of the arc generated between the fixed and movable contactors is negatively affected due to the Lorentz force causing an extension of the arc in a direction orthogonal to the closing direction. For this reason, the contact mechanism is provided with magnetic bodies disposed on the fixed contactor and/or the movable contactor for suppressing the driving force exerted on the arcs. Thus, this contact mechanism has the disadvantage of increasing the number of parts with associated increase in size and manufacturing costs of the contact mechanism.

Patent Application No. JP 2021093277A aims at providing an electromagnetic contactor which is capable of attaining improvement in cut-off performance by preventing an arc which is generated between a stationary contact and a movable contact from moving to the inside of a movable contact element in a length direction, which could cause a short-circuit with metal parts inside the electromagnetic contactor. The electromagnetic contactor includes C-shaped fixed contacts and a movable contact with an intermediate elongated design for generating a Lorentz force onto the arc currents across the fixed and movable contacts that may suppress the Lorentz force produced by the C-shaped fixed contact. In addition, magnetic plates may be attached to the inner surfaces of the fixed contacts so that the magnetic field generated by the current flowing through the fixed contact is shielded for reducing the Lorentz force acting on the arc. However, the proposed design still has the disadvantage of having a considerable overall size, namely, due to the configuration of the input and output terminals arranged on top of the fixed contacts, and/or of requiring use of additional magnetic components.

Consequently, there is still a need for contactor mechanisms and electromagnetic contactors of a compact size that are capable of providing reliable switch-off protection, namely, under the operating requirements mentioned above, and which requires a minimum addition of parts, such as of magnetic components.

### BRIEF DESCRIPTION OF THE INVENTION

The present invention has been made in view of the shortcomings and disadvantages of the prior art, and an object thereof is to provide contactor mechanisms, and electromagnetic contactors comprising the same, capable of offering enhanced short-circuit protection, improved switch-off capability, and which minimizes contact resistance within an optimized, compact size.

This object is solved by the subject matter of the independent claims. Particular embodiments of the present invention are subject matter of the dependent claims.

In an embodiment, a contactor mechanism is provided with a design of at least one of the stationary and movable contacts that effectively uses recirculation of the current that crosses the contactor mechanism to enable a leverage of the repulsive Holms forces generated between the stationary and movable contacts, thereby enhancing the effective, overall contact force in the event of a short-circuit.

In various embodiments, the contactor mechanism is so designed that the current transported by at least one of its stationary contacts is recirculated around a contact section of the movable contact, thereby generating Lorentz forces between the stationary and movable contacts that supplement the contact force produced by an electromagnetic driving system to keep the contact system closed. Consequently, by using the recirculated current itself, it is possible to leverage the repulsive effect associated with the Holms forces that tend to pull the movable and stationary contacts apart and which may lead to a collapse of the contact system in the event of a short circuit.

In addition, the stationary contacts are designed so that the respective input and output terminals are disposed along a direction which is rotated by a non-zero angle, for e.g. by a 90° rotation, with respect to the direction of the longitudinal length of the movable contact. This 90° rotation allows increasing the overlapping length of the current paths along the stationary and movable contacts. Furthermore, it allows extra space perpendicularly to the moveable contact and facilitates an expansion in the “volume” needed for elongating the length of the electric arc produced between the contacts during switch-off events. The expanded usable “volume” achieved by the 90° rotation of the input and output terminals opens up the possibility of incorporating one or more arc chutes so as to enhance the switch-off capabilities or even reduce the overall size of the contactor.

As a result, the subject matter herein allows producing contactor mechanisms, also referred to as contact systems hereinafter, and electromagnetic contactors of a compact size that can withstand a very high current discharge, namely of the order of 15 kA and above, without collapsing.

According to an embodiment, a contact system for an electromagnetic contactor is provided including: a movable contact configured to move along a closing direction of the contact system; and a first stationary contact and a second stationary contact disposed facing each other along a longitudinal direction transverse to the closing direction; wherein each of the first stationary contact and the second stationary contact has a C-shaped body with a first leg and a second leg oriented towards a center of the contact system and spaced apart along the closing direction, wherein the movable contact has a first movable contact section disposed between the first leg and the second leg of the first stationary contact and a second movable contact section disposed between the first leg and the second leg of the second stationary contact, and the first stationary contact and the second stationary contact each comprise a terminal section that extends from the respective second leg towards an alignment direction that forms a non-zero angle with the longitudinal direction of the contact system.

According to a further development, the alignment direction forms a right angle with the longitudinal direction and the closing direction of the contact system, and/or the terminal section of the first stationary contact is disposed opposite to the terminal section of the second stationary contact with respect to the longitudinal direction of the contact system.

According to a further development, the first stationary contact and the second stationary contact each include an intermediate section between the respective first and second legs, each second leg including an extension section which extends substantially in parallel to the longitudinal direction towards the center of the contact system and having an edge to which the terminal section is connected, and wherein the edges are inclined with respect to the longitudinal direction and oriented towards opposite sides of the contact system.

According to a further development, each of the first extension section and the second extension section extends in the longitudinal direction towards each other over a length which is substantially half of the length of the movable contact in the longitudinal direction.

According to a further development, the contact system is closed by moving the movable contact into a closed state position at which the first movable contact section is in contact with the first leg of the first stationary contact and the second movable contact section is in contact with the first leg of the second stationary contact.

According to a further development, each terminal section is configured as a flat plate oriented parallel to both the alignment direction and the longitudinal direction and provided with a through-hole for connecting to an input or output terminal of an external load.

According to a further development, the movable contact is comprised of one or more movable contact elements extending in the longitudinal direction and arranged side by side, each of the one or more movable contact elements comprising a first movable contact section disposed between the first leg and the second leg of the first stationary contact and a second movable contact section disposed between the first leg and the second leg of the second stationary contact, and wherein each of the first movable contact sections is configured to make contact with the first leg of the first stationary contact and each of the second movable contact sections is configured to make contact with the first leg (130a; 430a; 530′a, 530″a; 630a) of the second stationary contact when the contact system is closed.

According to a further development, each of the one or more movable contact elements is configured as a flat bar extending in the longitudinal direction; or each of the one or more movable contact elements is configured as an inverted U-shaped bar having an intermediate section that protrudes, in the closing direction, through a separation region between the first stationary contact and the second stationary contact.

According to a further development, the contact system further comprises one or more permanent magnets arranged within a space surrounded by the U-shaped intermediate section of the movable contact.

According to a further development, the contact system further comprises: a support structure for fixing a driving shaft to an intermediate section of the movable contact, wherein the support structure is configured to support the driving shaft oriented along the closing direction and towards an outside of the contact system. The subject matter herein also provides an electromagnetic contactor with a contactor system according to the subject matter herein and an electromagnetic driving system configured to operate the contact system to switch between a closed state and an open state.

According to a further development, the electromagnetic driving system comprises an electromagnetic coil and a movable magnetic core configured to couple to a driving shaft, wherein the movable magnetic core is configured to move the driving shaft in the closing direction, when actuated by an electromagnetic actuation force generated by the electromagnetic coil, to move the movable contact towards the first and second stationary contacts and close the contact system.

According to a further development, the electromagnetic driving system further comprises a return spring coupled to the movable magnetic core on a side opposite to a side coupled to the driving shaft, wherein the return spring is compressed by the movable magnetic core in the closing direction when the electromagnetic coil is energized to maintain the contact system closed, and wherein the return spring decompresses and moves the movable magnetic core and the driving shaft in a direction opposite to the closing direction when the electromagnetic coil is de-energized to open the contact system.

According to a further development, the electromagnetic contactor is made as an assembly of a first module unit and a second module unit, the first module unit comprises a first-half housing and the contact system accommodated inside the first-half housing, the first-half housing includes a through-hole for passing a part of the driving shaft coupled to the contact system to outside the first-half housing, and the second module unit comprises a second-half housing and the electromagnetic driving system accommodated inside the second-half housing, the second-half housing includes a through-hole for inserting the part of the driving shaft protruding from the first-half housing for coupling with the electromagnetic driving system.

According to a further development, the electromagnetic driving system further comprises: one or more arc chutes arranged in proximity of a contact region between the movable contact and each of the first stationary contact and the second stationary contact.

Thus, the subject matter herein makes possible to deal with overcurrent protection without increasing the power consumed by the electromagnetic driving system. Further, as the additional Lorentz forces are produced proportionally to the overcurrent intensity, an effective compensation of the repulsive forces can be reached at all times.

Further technical advantages of the subject matter herein are an increase of shock resistance due to the additional attraction between contacts. This also results in an increased contact force and consequently, reduced contact resistance.

The accompanying drawings are incorporated into and form a part of the specification for the purpose of explaining the principles of the invention. The drawings are not to be construed as limiting the invention to only the illustrated and described examples of how the invention can be made and used.

### BRIEF DESCRIPTION OF THE DRAWINGS

Further features and advantages will become apparent from the following and more detailed description of the invention as illustrated in the accompanying drawings, in which:

FIG. 1 is a perspective view of a contactor mechanism according to a first embodiment, wherein the contactor mechanism is shown in a closed state and with the side of a movable contact coupled to a driving shaft oriented upwards;

FIG. 2 is further perspective view of the contactor mechanism according to the first embodiment, wherein the contactor mechanism is shown with the side of the input and output terminals oriented upwards;

FIG. 3 is a graph showing simulation results for the magnetic induction B generated by a current circulating in the direction of the horizontal arrow across a contactor mechanism with the configuration shown in FIG. 1 and the directions of the repulsive Lorentz force F1 applied onto the movable contact and the repulsive Lorentz force F2 applied onto the stationary contacts of the contactor mechanism;

FIG. 4 shows schematically (a) the direction of current flow along a contactor mechanism with the C-shape design shown in FIG. 1 and which closes in a reverse direction, i.e. in the downward direction of the solid arrow towards the electromagnetic driving system, and the generated add-on Lorenz forces F1 and F2, and (b) the direction of current flow along a conventional contactor mechanism which closes in the standard direction, i.e. in the upward direction of the solid arrow, away from the electromagnetic driving system;

FIG. 5 is perspective view of an electromagnetic contactor comprising a contactor mechanism with the configuration shown in FIG. 1, the electromagnetic contactor being shown with the side of the input and output terminals oriented upwards and cross-sectioned along a closing direction of the contactor mechanism;

FIG. 6 is a cross-sectional view of the electromagnetic contactor shown in FIG. 5;

FIG. 7 is a schematic view of a contactor mechanism according to a second embodiment, the contactor mechanism being shown with the side coupled to a driving shaft oriented in an upward direction;

FIG. 8 is a perspective view of a contactor mechanism according to a third embodiment (viewed from a side that couples to a driving shaft oriented in an upward direction); and

FIG. 9 is a perspective view of a contactor mechanism according to a fourth embodiment, where the contactor mechanism is shown in an open state and with the side coupled to a driving shaft oriented in an upward direction.

### DETAILED DESCRIPTION OF THE INVENTION

The present invention will now be more fully described hereinafter with reference to the accompanying drawings, in which exemplary embodiments of the invention are shown. The present invention may, however, be embodied in many different forms and should not be construed as limited to the embodiments set forth herein. Rather, these embodiments are provided so that the disclosure will be thorough and complete, and will fully convey the scope of the invention to those skilled in the art. Like numbers refer to like elements throughout.

FIG. 1 shows a contact system 100 according to a first embodiment. The contact system 100 comprises a movable contact 110 and a pair of stationary contacts 120, 130 (hereinafter, referred to as a first stationary contact 120 and a second stationary contact 130) configured with a specific design that leverages the repulsive Holms forces generated between the movable contact 110 and the stationary contacts 120, 130. The movable contact 110 and the stationary contacts 120, 130 are made of electrically conductive materials.

The movable contact 110 is provided as a single flat bar that extends in a longitudinal direction 140 over a length L (e.g. along the X-axis direction shown in FIG. 1). The movable contact 110 is movable in a closing direction 150, transverse to the longitudinal direction 140, towards the stationary contacts 120, 130, thereby bridging a separation gap between contact sections 120a, 130a of the stationary contacts 120, 130, respectively, to close the contact system 100. The electrical contact with each of the stationary contacts 120, 130 is made via contact sections 110a, 110b (hereinafter referred to as first and second movable contact sections) at opposite ends along the longitudinal direction L of the movable contact 110.

Both the first and the second stationary contacts 120, 130 are designed with C-shaped bodies when viewed from a direction orthogonal to the longitudinal direction 140 (for e.g. along the Z-axis direction in FIG. 1), each having a pair of legs spaced apart in the closing direction 150 and extending along the longitudinal direction 140, towards the center of the contact system 100. As shown in FIG. 1, the movable contact 110 is movable in the closing direction 150 within an inner space delimited by the first and the second stationary contacts 120, 130 and is disposed with the first movable contact section 110a between the first leg 120a and the second leg 120c of the first stationary contact 120 and the second movable contact section 110b between the first leg 130a and the second leg 130c of the second stationary contact 130. The first legs 120a, 130a form the contact sections with which the movable contact 110 makes electrical contact when the contact system 100 is closed. The C-shaped bodies of the first and the second stationary contacts 120, 130 result in the current across the closed contact system 100 being circulated around the movable contact 110, thereby generating repulsive Lorentz forces that contribute to push the movable contact 110 against the legs 120a, 130a of the first and the second stationary contacts 120, 130, as it will be explained later.

The contact sections 110a, 110b of the movable contact 110 are connected by an intermediate, central region 110c provided with protruding features, e.g. flanges that extend from opposed sides in a direction orthogonal to the longitudinal length L for fixing a support structure 200 to the movable contact 110. The support structure 200 carries a driving shaft 210 coupled to a contact spring 220 which is positioned in contact with an upper side of the intermediate section 110c for applying a contact force onto the movable contact 110. The driving shaft 210 is movable along the closing direction 150, for e.g. along the Y-axis direction shown in FIG. 1, to drive the movement of the movable contact 110 along this direction between two positions corresponding to a closed state and an open state of the contact system 100. In the closed state position, such as shown in FIG. 1, the movable contact 110 is displaced in the closing direction 150 until the contact sections 110a, 110b of the movable contact 110 become in electrical contact with the corresponding contact sections 120a, 130a of the stationary contacts 120, 130, respectively, thereby closing the electric path between the first and second stationary contacts 120, 130. In the open state position, the movable contact 110 is displaced in the opposite direction, away from the contact sections 120a, 130a, so that the electric path between the stationary contacts 120, 130 is interrupted.

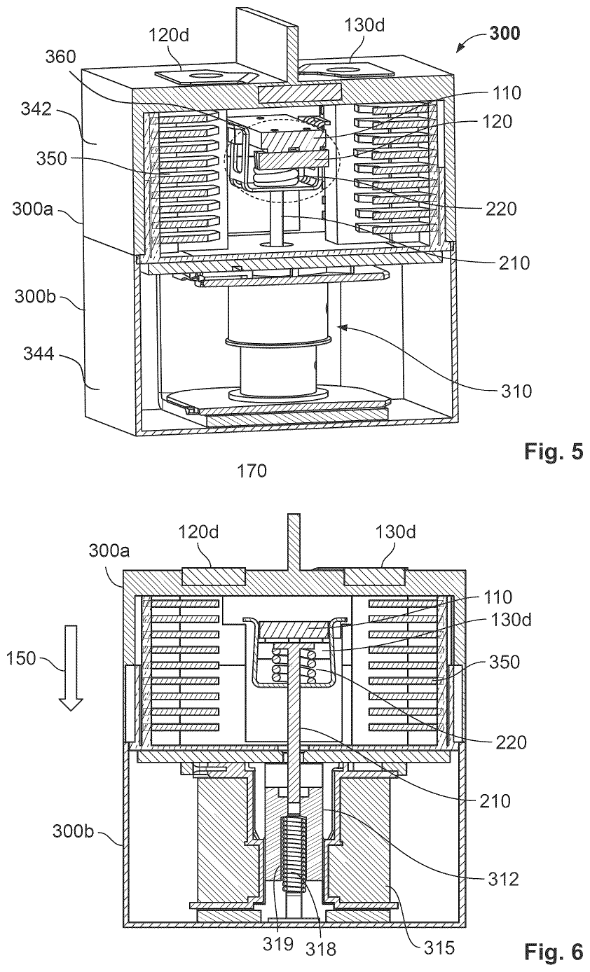

As shown in FIG. 5, the support structure 200 is designed to be mounted onto the upper side of the movable contact 110, which is the side facing the electromagnetic driving system 310 when mounted in an electromagnetic contactor 300. Since the support structure 200 is placed on an outer side of the contact system 100, it is possible to reduce the inner space between the movable contact 110 and the second legs 120c, 130c of the stationary contacts 120, 130 and therefore, the distance between the currents flowing along these sections. This has the benefit of increasing the strength of the generated repulsive Lorenz forces and of reducing the overall size of the contactor mechanism 100 in the closing direction 150. The contact spring 220 allows to maintain a good contact between the movable contact 110 and the driving shaft 210 at all times and to compensate an oscillation of the movable contact 110 caused by unbalanced repulsive Holm forces generated at the left and right sides of the movable contact 110.

The first stationary contact 120 and the second stationary contact 130 are each disposed on opposite sides of the movable contact 110 in the longitudinal direction 140, for e.g. on the left and right of the movable contact 110 when viewed from the side shown in FIG. 1, respectively, and arranged with the contact sections 120a, 130a facing the upper side of the contact sections 110a, 110b of the movable contact 110, respectively.

Specifically, the stationary contact 120 is configured with an intermediate section 120b which is bent on a upper part and a lower part by approximately 90°, towards the movable contact 110. The first contact section 120a (or first leg) is formed as a flat portion that extends from the upper part of the intermediate section 120b, thereby extending in a direction parallel to the upper side of the movable contact 110 and such as to overlap the contact section 110a of the movable contact 110. On the opposite side of the C-shaped body, the stationary contact 120 has as a second leg with an extension section 120c that extends, from the lower part of the intermediate section 120b, in parallel to a lower side of the movable contact 120 and over part of its longitudinal length L. At approximately half of the longitudinal length (L/2) of the movable contact 110, the extension section 110c adopts a curved shape with an edge 120e that deviates away from the longitudinal direction 140 towards an alignment direction 160, which is transverse to the closing direction 150 of the contact system 100 and forms a non-zero angle with the longitudinal direction 140, for e.g. an angle of 90° as shown in FIG. 1.

In addition, the stationary contact 120 is configured with a terminal section 120d for connecting the contact system 100 to a terminal of an external load (not show), for. e.g. an output terminal. The terminal section 120d of the stationary contact 120c is connected to the inclined edge 120e of the extension section 120c so that the terminal section 120d is not positioned below the movable contact 110 but deviated therefrom by a given non-zero angle, e.g. 90°, in the alignment direction 160. The terminal section 120d is designed as a flat plate oriented in a plane transverse to the closing direction 150 of the contact system 100 (e.g. in the plane XZ in FIG. 1) for connecting to a load terminal from a vertical direction.

The second stationary contact 130 is also configured with a C-shaped body similar to the first stationary contact 120. As shown in FIG. 1, the C-shape body of the second stationary contact 130 comprises an intermediate section 130b which is bent on an upper part by approximately 90°, towards the movable contact 110, and from which the contact section 130a (first leg) extends in a direction parallel to the upper side of the movable contact 110 so as to overlap the contact section 110b of the movable contact 110 located underneath. In addition, the intermediate section 130b is bent on an lower part from which the second leg with an extension section 130c extends, below a lower side of the movable contact 110 and along the longitudinal direction 140, towards the center of the contact system 100. The contact section 130a and the extension section 130c are both configured as flat plates oriented to be substantially orthogonal to the closing direction 150. Moreover, the extension section 130c is also designed with a curved shape having an edge 130e that deviates away from the longitudinal direction 140, i.e. towards a direction transverse to the closing direction 150 of the contact system 100, by a non-zero angle, such as −90°, and opposed to the direction of deviation of the inclined edge 120e of the extension section 120c of the first stationary contact 120.

The terminal section 130d of the stationary contact 130to which the other terminal of the load (not shown) can be electrically connected, for e.g. the input terminal, is extends from the inclined edge 130e of the extension section 130c such that it is also deviated away from the longitudinal direction 140. As a result, the terminal section 130d is not positioned below the movable contact 110 but is rotated therefrom by a given non-zero angle, e.g. −90°, with respect to the alignment direction 160.

Thus, according to this configuration, the terminal sections 120d, 130d extending from the second legs 120c, 130c of the stationary contacts 120, 130 are deviated away from the longitudinal direction 140, in opposite directions, such as to be disposed along an alignment direction 160 that forms a non-zero angle with the longitudinal direction 140 of the contact system 100.

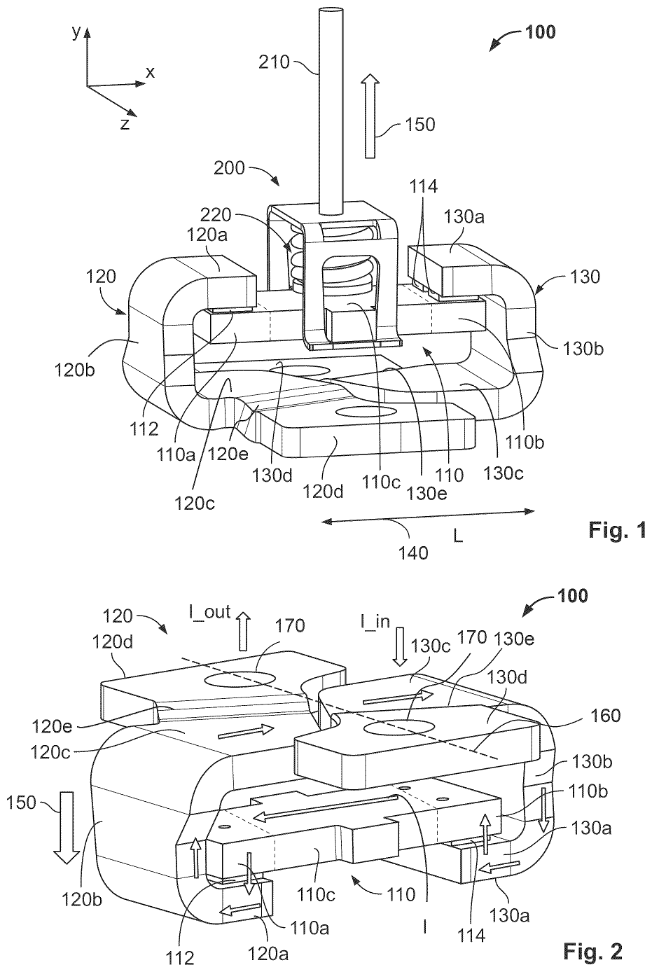

FIG. 2 shows the movable contact 110 and the stationary contacts 120, 130 of the contact system 100, without the support structure 200, viewed from a lower side, which is the side of the terminal sections 120d, 130d to be connected to the load terminals (not shown). As shown in FIG. 2, the specific design of the first and second stationary contacts 120, 130 results in the contact system 100 having the terminal sections 120d, 130d to which the output and input terminals of a load will be connected aligned along the alignment direction 160 that is rotated by a reverse angle, e.g. 90°, with respect to the other branches of the respective stationary contacts 120, 130 (i.e. along the Z-axis direction in FIG. 1). This alignment direction 160 is substantially orthogonal to the longitudinal direction 140 of the movable contact 110 and the closing direction 150 of the contact system 100, and therefore, distinct from a terminal alignment in the longitudinal direction 140 of the movable contact 110, as conventionally used in the prior art.

The 90° reverse alignment of the terminal sections 120 d, 130 d provides several advantages over the standard, longitudinal alignment of input and output terminals used in the prior art, such as in the electromagnetic contactors discussed in the background section above.

Firstly, the 90° reverse alignment allows to maximize the length of the extension sections 120c, 130c which may then extend over approximately half of the length L of the movable contactor 110. This leads to a maximization of the overlapping between the current path along the longitudinal length of the movable contact 110 and the currents paths along the stationary extension sections 120c, 130c on either side of the movable contact 110, and therefore, of the Lorenz forces generated between the movable contact 110 and the stationary contacts 120, 130. For instance, as shown in FIG. 2, an incoming current (I_in) input on the stationary terminal section 130d is first circulated along the extension section 130c, in parallel to the movable contact 110, and then around the movable contact section 110b of the movable contact 110, along the C-shaped stationary contact 130, towards the stationary contact section 130a from which it passes to the movable contact 110. The incoming current I is then transported along the longitudinal direction 140 of the movable contact 110, substantially in parallel to the current paths on the opposed extension section 130c, towards the stationary contact 120, which receives this current from the contact section 120a. The received current is then circulated along the C-shaped stationary contact 120, around the movable contact section 110a of the movable contact 110, and transported in the extension section 120c along current paths parallel to the current direction I in the movable contact 110 before exiting at the terminal section 120d (I_out). As a result, since the C-shape of the stationary contacts 120, 130 surrounds the movable contact 110, at least partially, the passage of current along the extension sections 120c, 130c generates a Lorenz force F1 onto the movable contact 110 of a repulsive character due to these currents flowing in a sense opposed to the current flow I on the movable contact 110. Similarly, the current circulation across the contact system 100 leads to the generation of repulsive Lorenz forces F2, i.e. oriented in the opposite direction of the Lorenz force F1, that are applied on each of the extension sections 120c, 130c of the stationary contacts 120, 130. FIG. 4(a) shows a simplified representation of the currents paths (solid arrows) along the movable contact 110 and the stationary contacts 120, 130 when the contact system 100 is closed and the direction of the respective Lorenz forces F1 and F2.

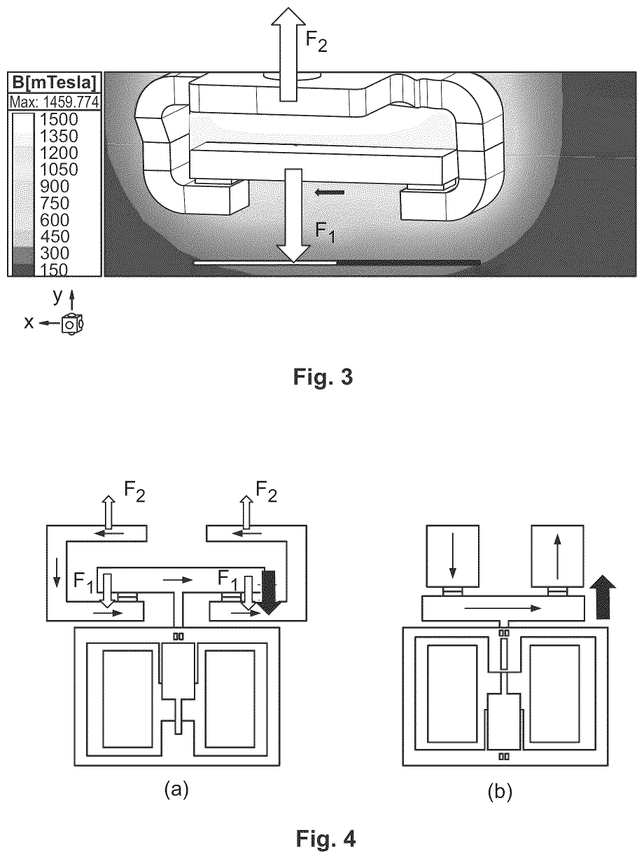

FIG. 3 shows simulation results of the magnetic induction B generated by the current circulating on the upper branches of the stationary contacts 120, 130 and the movable contact 110 (along the direction of the solid arrow) and the direction of the generated repulsive Lorentz forces F1 and F2.

The repulsive Lorentz forces F1 applied onto the movable contact 110 and the Lorenz forces F2 applied on each of the stationary contacts 120, 130 act in opposed directions, resulting in an add on force that supplements the contact force applied by the driving shaft 210 on the movable contact 110 to maintain the contact system 100 closed during normal operating conditions. Thus, in case the contact system 100 operates to interrupt a very high-current in the event of a short-circuit, the repulsive Holm forces generated by the discharge current across the contacts regions between the movable contact 110 and the stationary contacts 120, 130 can be counter-acted by the repulsive Lorenz forces generated by the circulation effect of the current passing across the closed contact system 100.

Secondly, the 90° reverse alignment of the terminal sections 120 d, 130d allows maximizing the length of the extension sections 120d, 130d and therefore, increasing the strength of the repulsive Lorenz forces for a given length of the movable contact 110. Thus, this design favors a compact size of the contact system 100 in the longitudinal direction 140. In addition, the design of the terminal sections 120d, 130d as flat plates which are oriented in parallel to the extension sections 120c, 130c, i.e. orthogonal to the closing direction 150, also allows to reduce the size of the contact system 100 in closing direction 150.

Thus, the C-like shape with extension sections 120c, 130c of each of the stationary contacts 120, 130 together with the 90° reverse alignment of the respective output and input terminals 120d,130d allows to achieve a leverage of the repulsive forces between the movable contact 110 and each of the stationary contacts 120, 130, thereby enhancing the effective contact force when a high current is interrupted in the event of a short-circuit. Thus, the speed at which the contact system 100 will open in the event of a short circuit is also leveraged. Furthermore, it ensures that the contact system 100 does not accidentally open at currents below a desired threshold. In this sense, the design of the contact system 100 provides effective short-circuit prevention.

The electrical contact between the movable contact 110 and each of the stationary contacts 120, 130 is made via a set of contact islands 112, 114 arranged on at least one of the respective facing sides. For instance, in the configuration shown in FIG. 1, a pair of adjacent contact islands 112 is formed in the movable contact section 110a, on an upper side that faces the stationary contact section 120a, to divide the flow of electrical current in two branches. Similarly, the movable contact section 110b on the right side includes a pair of adjacent contact islands 114 arranged on the upper side facing the stationary contact section 130a. Each of the stationary contact sections 120a, 130a may also be provided with a corresponding pair of contact islands (not shown), arranged on the side facing the movable contact 110 and aligned with the corresponding contact islands 112, 114 in the facing movable contact sections 110a, 110b. The contact islands 112, 114 thus form the sole regions through which the movable contact 110 and the stationary contacts 120, 130 of the contact system 100 can establish mechanical and electrical contact with each other, and consequently, ensure that the current transported by the movable contact 110 is circulated along the C-shaped paths established in the first and second stationary contacts 120, 130, thereby improving contact stability.

An exemplary electromagnetic contactor 300 comprising the contact system 100 is illustrated in FIGS. 5 and 6.

The electromagnetic contactor 300 includes an electromagnetic driving system 310 which is mechanically coupled to the movable contact 110 via the driving shaft 210 and which generates a contact force for holding the movable contact 110 in the closed position, i.e. against the stationary contacts 120, 130, under normal operating conditions. For instance, the electromagnetic driving system 310 includes a movable magnetic core 312 (for e.g. an iron core) and an electromagnetic coil 315 which is configured to generate an electromagnetic actuating force that actuates onto the movable magnetic core 312 when supplied with an energizing current. Under an appropriate energizing current, the generated electromagnetic force causes a displacement of the movable magnetic core 312 in the closing direction 150 of the contact system 110. The movable core 312 is then plunged towards the magnetic coil 315, thereby moving the driving shaft 210 coupled thereto in the closing direction 150 and pressing a return spring 318 accommodated in an inner cavity 319 of the movable magnetic core 315. As a result, the movable contact 110 is pressed against the stationary contacts 120, 130 and the contact system 100 is closed. When the electromagnetic coil 315 is de-energized, the electromagnetic actuating force vanishes and the magnetic core 315 is pushed back, together with the driving shaft 210, in the direction opposite to the closing direction 150 by the release force of the return spring 318. As a result, the movable contact 110 separates away from the stationary contacts 120, 130 and the contact system 100 opens.

In other words, the contact system 100 is closed when the electromagnetic coil 315 generates an actuation force sufficient to maintain the contacts 110, 120, 130 closed and opens when the coil 315 is de-energized (e.g. due to a short-circuit event).

The contact system 100 is mounted inside a housing 340 of the electromagnetic contactor 300. The stationary contacts 120, 130 are fixed to the housing 340 and mounted with the terminal sections 120d, 130d disposed on an external side of the housing 340 for connecting to the output and input terminals of a load or power circuit to be protected (not shown) by the contact system 100. The terminal sections 120d, 130d may be provided with through-holes f170 or receiving or plugging the load terminals.

The electromagnetic contactor 300 may be provided with arc chutes 350 disposed inside the housing 340 and on either side of the contact system 100, for e.g. adjacent to a contact region 360 between the movable contact 110 with each of the stationary contacts 120, 130 for dissipating the arc currents that may arise when the contact system 100 abruptly opens to interrupt a high current discharge.

The housing 340 protects the contact system 100 from the external environment (e.g. humidity) and prevents obstructions to the operation of the contact system 100. The housing 340 may be a modular housing, for e.g. formed by a first half 342, which is configured to arrange the contact system 100 inside, and a second half 344 configured to arrange the contact system 100 inside, such as shown in FIGS. 5-6. The first and second housing halves 342, 344 may be provided as self-contained and closed units that can be assembled together to form the housing 340 of the electromagnetic contactor 300. For instance, the first half 342 may be configured as a closed housing unit with a through-hole on a side that faces the second half 344 for allowing the driving shaft 210 to couple with the electromagnetic driving system 310 arranged inside, thereby forming a first module unit 300a. The second half 344 may be also configured as a closed housing unit with a through-hole on a side that faces the first half 342 and from which the driving shaft 210 coupled to the contact mechanism 100 arranged inside can protrude for coupling with the electromagnetic driving system 310 arranged in the second half 344, thereby forming a second module unit 300b. Thus, the electromagnetic contactor 300 can be designed to be modular, enabling easy configuration with various coil setups and contact mechanism options. The modular design also facilitates assembly of the electromagnetic contactor 300.

As mentioned above, the recirculation of a high current along the C-shaped current paths that envelop the movable contact 110 from the left and right sides result in the generation of repulsive Lorenz forces between the extension sections 120c, 130c and the movable contact 110 which tend to press the movable contact 110 against the contact sections 120a, 130a, thereby adding on the contact force to keep the contact system 100 closed. Moreover, it should be noted that the current recirculation also includes parallel current paths established along the stationary contact sections 120a, 130a and the movable contact sections 110a, 110b, which transport current in the same sense. These currents also originate additional Lorenz forces, here of an attractive nature but which also tend to push the movable contact 110 and the stationary contacts 120, 130 against each other, thereby also adding on the contact force to keep the contact system 100 closed.

Thus, the contact force produced by the electromagnetic coil 315 to maintain the contact system 100 closed is automatically supplemented with additional forces produced alone by the circulation of the current along the contact system 100 and without the need of adding additional magnetic components to the contact system 100 or to increase the energizing current of the electromagnetic driving system 310.

Moreover, as the Lorentz forces increase with the intensity of the circulating current, length of the parallel current paths and with a reduction of the separation distance between the parallel current paths, the dimensions of the movable contact 110 and stationary contacts 120, 130 as well as the separation distance between them may be set according to the particular application of the contactor, so as to produce add-on forces of a suitable intensity. For instance, the additional repulsive Lorentz forces can be increased by increasing the overlapping length of the parallel current paths along the movable contact 110 and each of the stationary contacts 120, 130 in the longitudinal direction. In particular, the length of the extension sections 120c, 130c is preferably the same or close to half of the longitudinal length L of the movable contact 110 in order to maximize the add-on, repulsive Lorentz forces.

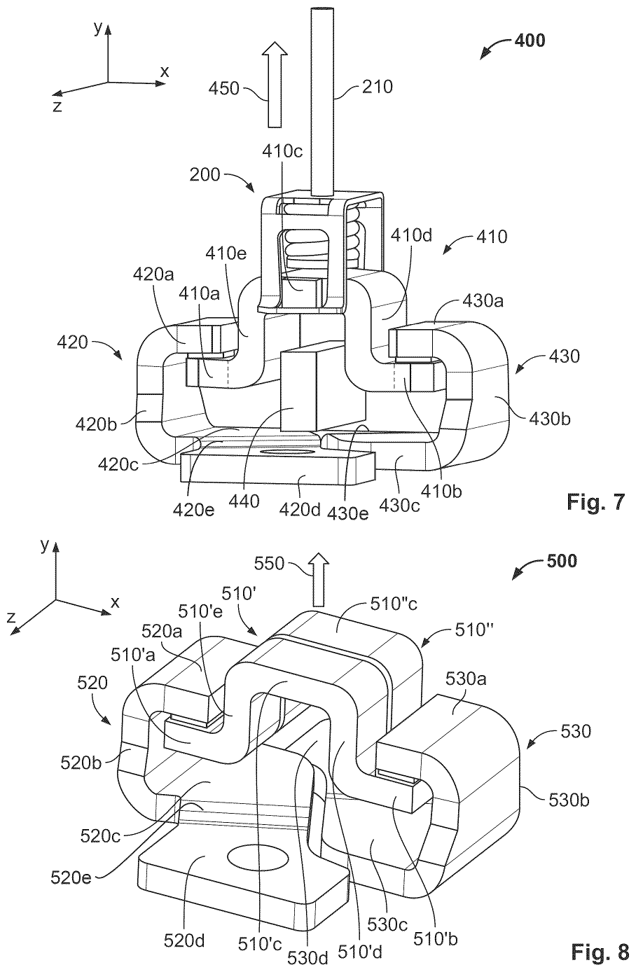

The principles underlying the effects achieved with specific shape of the stationary contacts 120, 130 described with reference to the first embodiment can be advantageously applied to other configurations of contact systems, as it will be explained below we reference to FIGS. 7-9.

FIG. 7 shows a contact system 400 according to a second embodiment. The contact system 400 comprises a movable contact 410 and a pair of stationary contacts 420, 430 (hereinafter, referred to as a first stationary contact 420 and a second stationary contact 430), Similarly to the contact system 100 described above, the movable contact 410 can move relative to the stationary contacts 420, 430 along the closing direction 450, i.e. along the Y-direction in FIG. 7, so as to switch between closed and open states under actuation of a driving system, such as the electromagnetic driving system 310 described above with reference to FIGS. 5 and 6. The stationary contacts 420, 430 are configured with the same design as the stationary contacts 120, 130 described above. Specifically, both stationary contacts 420, 430 are designed with C-shaped bodies (when viewed from the Z-axis direction in FIG. 7), each having a respective pair of legs 420a, 420c and 430a, 430c spaced apart in a closing direction 450 of the contact system 400 by respective intermediate sections 420b, 430b and that extend along the longitudinal direction (the direction of the X-axis in FIG. 7), transverse to the closing direction 450 and towards the center of the contact system 400. In addition, similarly to the first embodiment, each of the stationary contacts 420, 430 also includes respective terminal sections 420d, 430d extending from the legs 420c, 430c of the stationary contacts 420, 430, respectively, and disposed, in opposite sides of the longitudinal direction, along an alignment direction (the direction of the Z-axis in FIG. 7) that forms a non-zero angle with the longitudinal direction of the contact system 400. Consequently, the effect of leveraging the repulsive Holm forces at the contact points between the movable contact 410 and the stationary contacts 420, 430 is similar to the first embodiment and will not be repeated hereinafter.

Similarly to the first embodiment, the movable contact 410 establishes electrical contact with each of the stationary contacts 420, 430 via contact sections 410a, 410b (hereinafter referred to as movable contact sections) located at opposite ends, along the longitudinal direction of the movable contact 410, and facing corresponding contact sections 420a, 430a in the first legs of the stationary contacts 420, 430, respectively. However, the movable contact 410 differs from the first embodiment in a central, intermediate section 410c being elevated in the closing direction 450 of the contact system 400 by lateral branches 410d, 410e connected to the contact sections 410b, 410y, respectively, thereby forming an inverted U-shape (when viewed from the Z-axis direction in FIG. 7). The opening of the U-shape is thus turned downwards, i.e. in the direction opposed to the closing direction 450. The intermediate region 410c to which the support structure 200 is attached has similar fixing flanges as described above with reference to FIG. 1. In addition, in the contact system 400 the coupling with the support structure 200 carrying the driving shaft 210 is still made from a top side of the intermediate section 410c, such as in the first embodiment. The closing and opening operations of the contact system 400 is therefore similar to the operation described above for the first embodiment.

The inverted U-shape configuration of the movable contact 410 provides additional space between the movable contact 410 and the stationary contacts 420, 430 and which can be used for accommodating additional parts in the interior of the contact system 400, such as a permanent magnet 440 to enhance arc extinguishing capabilities. For instance, the magnetic induction introduced by the permanent magnet 440 may add an additional force for counter-acting a deviation of the arc, which can be formed across the contact points between the movable contact 410 and the stationary contacts 420, 430, towards the center of the contact system 400 due to the Lorenz force generated by the current circulating along the vertical sections 420b, 430b of the stationary contacts 420, 430. Moreover, although the intermediate section 410c is elevated in the direction of the driving shaft 210, i.e. towards the electromagnetic driving system, the contact system 400 does not present a strong compromise in terms of the volume occupied inside an electromagnetic contactor, such as the electromagnetic contactor 300 described above. For instance, the length of the driving shaft 210 may be shortened for compensating the increased height of the contact system 400 in the closing direction 450.

Thus, the contact system 400 still makes use of the specific C-shape design of the stationary contacts 420, 430 for achieving a leverage of the repulsive Holm forces via the Lorenz forces generated by the current circulation in the C-shaped contacts 420, 430 while allowing the incorporation of additional components inside the contact system 400, such as a permanent magnet 440, without compromising the contactor compact size.

FIG. 8 shows a contact system 500 according to a third embodiment. The contact system 500 comprises a pair of stationary contacts 520, 530 (hereinafter, referred to as a first stationary contact 520 and a second stationary contact 530) and differs from the second embodiment in comprising a pair of separate movable contact elements 510′, 510″ as the movable contact for establishing the contact bridge between the stationary contacts 520, 530. The stationary contacts 520, 530 are configured with the same design as the stationary contacts 120, 130 described above. Specifically, the stationary contacts 520, 530 are each designed with C-shaped bodies (for e.g. when viewed from the Z-axis direction in FIG. 8), each having a respective pair of legs 520a, 520c and 530a, 530c spaced apart in a closing direction 550 of the contact system 500 by respective intermediate sections 520b, 530b and extending along the longitudinal direction (the direction of the X-axis in FIG. 8), towards the center of the contact system 500. In addition, similarly to the first embodiment, each of the stationary contacts 520, 530 also includes respective terminal sections 520d, 130d that extend from the second legs 520c, 530c of the stationary contacts 520, 530 and disposed, in opposite sides of the longitudinal direction, along an alignment direction (e.g. along the direction of the Z-axis in FIG. 8) that forms a non-zero angle with the longitudinal direction of the contact system 500. Consequently, the leveraging effect of the repulsive Holm forces at the contact points between the movable contact 510 and the stationary contacts 520, 530 is similar to the first embodiment and will not be repeated hereinafter.

Similarly to the movable contact 410 of the second embodiment, the movable contact elements 510′, 510″ are each configured as bars with a U-shape design and similarly oriented with respect to the closing direction 550 of the contact system 500, i.e. with an inverted U-shape orientation with respect to the Y-axis direction shown in FIG. 8. For instance, as shown in FIG. 8, the first movable contact element 510′ has a central section 510′c which is elevated in the closing direction 550 and above the level of the stationary contact sections 520a, 530a by lateral, vertical branches 510′d, 510′e, at least when the contact system 500 is in the closed state. The contact sections 510′a, 510′b via which the movable contact 510′ makes electrical contact with the stationary contact sections 520a, 530a of the stationary contacts 520, 530, respectively, are then connected to the lateral branches 510′d, 510′e at right angles, from the left and right sides, thereby completing the U-shape of the first movable contact element 510′ (when viewed from the Z-direction). The second movable contact element 510″ is disposed adjacent to the first movable contact element 510′ in a direction orthogonal to the closing direction 550 and is configured with the same size and U-shape of the first movable contact element 510′, namely, with an elevated intermediate section 510″ connected to respective contact sections via vertical branches to form the U-shape.

A support structure carrying a driving shaft, e.g. the support structure 200, may be attached to both the first second movable contact elements 510′, 510″ from a top side of the intermediate sections 510′c, 510″c, such as described with reference to the second embodiment, for operating the contact system 500. The intermediate regions 510′c, 510″ may then include suitable flanges (not shown) for attaching the support structure 200, similarly to the configuration illustrated in FIG. 7.

The movable contact elements 510′, 510″ are then movable as a block along the closing direction 550 to bring the respective contact sections 510′a, 510″b and 510″a, 510″b on the left and right side into contact with the stationary contacts 520, 530, respectively, to close the contact system 500 under actuation of a driving system, such as the electromagnetic driving system 300 described above with reference to FIGS. 5 and 6.

The use of multiple movable contact elements 510′, 510″ for bridging the stationary contacts 520, 530 allows to divide the current passing through the contact system 500 over multiple, parallel branches and therefore, diminish contact repulsion forces and reduce contact resistance.

Moreover, by adopting multiple movable contact elements 510′, 510″ with U-shapes oriented with the intermediate sections 510′c, 510″c elevated in the direction of the driving shaft (not shown), the contact system 500 also offers increased space between the movable contacts 510′, 510″ and the stationary contacts 520, 530 for accommodating additional components, such as a permanent magnet (not shown), without strongly compromising its compact size. Thus, the contact system 500 still makes use of the specific C-shape design of the stationary contacts 520, 530 for achieving a leverage of the repulsive Holm forces via the Lorenz forces generated by the current circulation in the C-shaped contacts 520, 530, while allowing the incorporation of additional components inside the contact system 500 without compromising its compact size.

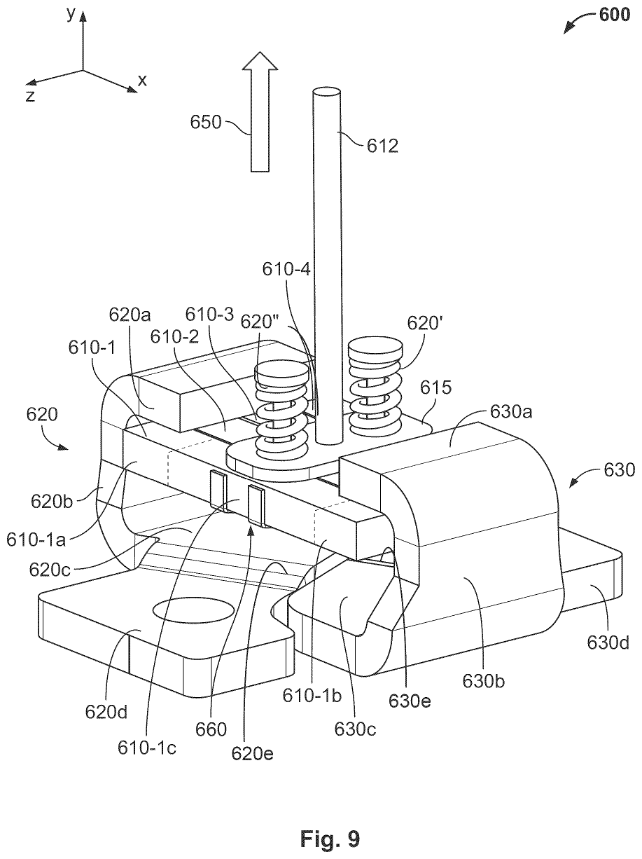

FIG. 9 shows a contact system 600 according to a fourth embodiment. The contact system 600 comprises a pair of stationary contacts 620, 630 (hereinafter, referred to as a first stationary contact 620 and a second stationary contact 630) and differs from the first embodiment in the comprising a plurality of separate movable contact elements 610-1 to 610-4 as the movable contact that establishes the contact bridge between the stationary contacts 620, 630. The first and second stationary contacts 620, 630 are each configured with the same design as the stationary contacts 120, 130 described above. Specifically, the stationary contacts 620, 630 are each designed with C-shaped bodies (when viewed from the Z-axis direction in FIG. 9), each having a respective pair of legs 620a, 620c and 630a, 630c spaced apart in a closing direction 650 of the contact system 600 by respective intermediate sections 620b, 630b and extending along the longitudinal direction (the direction of the X-axis in FIG. 9), towards the center of the contact system 600. In addition, similarly to the first embodiment, each of the stationary contacts 620, 630 also includes respective terminal sections 620d, 630d that extend from the second legs 620c, 630c of the stationary contacts 620, 630, respectively, and disposed, in opposite sides of the longitudinal direction, along an alignment direction (the direction of the Z-axis in FIG. 9) that forms a non-zero angle with the longitudinal direction of the contact system 600. Consequently, the leveraging effect of the repulsive Holm forces at the contact points between the movable contact 610 and the stationary contacts 620, 630 is similar to the first embodiment and will not be repeated hereinafter.

Similarly to the movable contact 110 of the first embodiment, the movable contact elements 610-1 to 610-4 are each configured as flat bars that extend along the same longitudinal direction to bridge the gap between the contact sections 620a, 630a of the first and second stationary contacts 620, 630, respectively, and disposed adjacent to each other in a direction orthogonal to the closing direction 650 of the contact system 600, i.e. in the Z-axis direction shown in FIG. 9. For instance, as shown in FIG. 9, the first movable contact element 610-1 is configured with a central section 610-1c between the contact sections 610-1a, 610-1b, on the left and right sides, through which the movable contact 610-1 makes electrical contact with the facing stationary contact sections 620a, 630a, respectively, when the contact system 600 is closed. The other movable contact elements 610-2 to 610-4 are configured with the same shape and size of the first movable contact element 610-1.

The plurality of movable contact elements 610-1 to 610-4 are disposed adjacent to each other in the direction orthogonal to both the closing direction 650 and the longitudinal direction L. The movable contact elements 610-1 to 610-4 are movable as a block along the closing direction 650 of the contact system 600, under the actuation of a driving shaft 612, so as to bring the respective contact sections, on the left and right sides, into contact with the contact sections 620a, 630a of the stationary contacts 620, 630, respectively, thereby closing the contact system 600. The contact system 600 may be operated under actuation of a driving system that causes a movement of the driving shaft 612 along the closing direction 650, such as the electromagnetic driving system 300 described above with reference to FIGS. 5 and 6.

In order to apply the contact force onto the four movable contact elements 610-1 to 610-4 simultaneously, the driving shaft 612 may be fixed to a plate 615 that extends in the direction orthogonal to the longitudinal direction L over the respective intermediate sections of the movable contact elements 610-1 to 610-4. An oscillation of the fixing plate 615 due to unbalanced forces or irregularities among the multiple movable contact elements 610-1 to 610-4 may be prevented by disposing contact springs 620′, 620″ onto the fixing plate 615, one on either side of the driving shaft 612. The contact springs 620′, 620″ and fixing plate 615 may be enclosed in a support structure similar to the support structure 200 shown in FIG. 1 and which is fixed, for e.g. to the movable contact elements 610-1 and 610-4, and arranged on the top side of the respective intermediate sections, such as over the intermediate section 610-1c shown in FIG. 9. The movable contact elements 610-1 to 610-4 may be rigidly fixed to a set 660 of one or more fixing bars that run under the lower side of the movable contact elements 610-1 to 610-4 so that these can be moved together as a block.

Although not illustrated in FIG. 9, the electrical contact between the movable contact elements 610-1 to 610-4 and the stationary contacts 620, 630 of the contact system 600 is preferably established via contact islands which may be formed on an upper side of the contact sections of the movable contact elements 610-1 to 610-4, such as on the contact sections 610-1a and 610-1b of the movable contact element 610-1 shown in FIG. 9, on a lower side of the contact sections 620a, 630a of the first and second stationary contacts 620, 630, or both.

The use of multiple movable contacts for bridging the stationary contacts 620, 630 allows to divide the current passing through the contact system 600 over multiple, parallel branches and therefore, diminish contact repulsion forces and reduce contact resistance. The contact system 600 is illustrated as comprising four movable contact elements 610-1c to 610-4c. However, the number of movable contact elements in the present embodiment is not limited to four.

Thus, the contact system 600 also makes use of the specific C-shape design of the stationary contacts 620, 630 described with reference to the first embodiment for achieving a leverage of the repulsive Holm forces via the Lorenz forces generated by the current circulation in the C-shapes, without compromising its compact size. The present configuration with multiple movable contacts may be advantageous for applications that require a contactor system with reduced dimension along the longitudinal length but not necessarily limited in the transverse direction. The effect of the reduced longitudinal length on the single movable contact on the add-on force generated by the repulsive Lorenz forces can then be compensated by the multiplying effect of a plurality of movable contacts arranged side by side. This configuration also allows to reduce contact resistance by dividing the current that passes across the contact system 600 among multiple branches.

Any of the contact systems described above with reference to FIGS. 7-9 may be implemented in an electromagnetic contactor, such as the electromagnetic contactor 300 described above with reference to FIGS. 5-6. The specific dimensions and the separation between contacts in any of the contact systems described above may be optimized by experimentation and/or using simulation methods known in the art according to the specific application and operating parameters, such as discharge currents to be withstand by the contact system, contact force generated by the magnetic coil, overall size constraints to be met by the contact system, conductive materials used for the contacts, including the contacts cross-section which has impact in the contact resistance. The materials used for production of the movable and stationary contacts are electrical conducting materials selected based on their capability of withstanding erosion and mechanical stress caused by repeated switching and offering stable resistance under arc discharges.

In conclusion, the contact systems in any of the configurations described above are designed such that the shapes of the stationary contacts and their placement relative to the movable contact allows to reinforce the contact force generated via by the electromagnetic driving system and therefore, leverage the repulsive Holm force generated by the flow of current through the contacts, at high discharge currents, such as 15 kA or higher, using the Lorentz forces which are self-generated by the re-circulation of current in the stationary contacts. Thus, the subject matter herein provides reliable contact systems and electromagnetic contactors for protecting electrical equipment used in high voltage applications and which have a compact size. Consequently, destruction of the contact system due to too abrupt opening of the contacts in the event of a short-circuit can be avoided.

In the description above the longitudinal direction is a direction along the X-axis in FIG. 1 and the closing direction is a direction orthogonal to the longitudinal direction, i.e. along the Y-axis. Moreover, the terms “upper side” or “upwards” have been used in the description above for referring to a side or a direction pointing in the closing direction of the contact system. Nonetheless, although certain features of the above exemplary embodiments were described using terms such as “top”, “bottom”, “upward”, “downward”, “upper” or “lower”, “left” and “right”, these terms were used for the purpose of facilitating the description of the respective features and their relative orientation only and should not be construed as limiting the use of the claimed invention to a particular spatial orientation. Moreover, although the present invention has been described above with reference to electromagnetic contactors for high current applications, the contact systems according to the principles of the present invention can be advantageously applied to relays and switching devices intended for low voltage applications.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Contact system for an electromagnetic contactor, comprising:
a movable contact configured to move along a closing direction of the contact system; and
a first stationary contact and a second stationary contact disposed facing each other along a longitudinal direction transverse to the closing direction; wherein
each of the first stationary contact and the second stationary contact has a C-shaped body with a first leg and a second leg oriented towards a center of the contact system and spaced apart along the closing direction,
the movable contact has a first movable contact section disposed between the first leg and the second leg of the first stationary contact and a second movable contact section disposed between the first leg and the second leg of the second stationary contact, and
the first stationary contact and the second stationary contact each comprise a terminal section that extends from the respective second leg towards an alignment direction that forms a non-zero angle with the longitudinal direction of the contact system.

2. A contact system according to claim 1, wherein
the alignment direction forms a right angle with the longitudinal direction and the closing direction of the contact system, and/or
the terminal section of the first stationary contact is disposed opposite to the terminal section of the second stationary contact with respect to the longitudinal direction of the contact system.

3. A contact system according to claim 1, wherein
the first stationary contact and the second stationary contact each include an intermediate section between the respective first and second legs,
each second leg includes an extension section which extends substantially in parallel to the longitudinal direction towards the center of the contact system and having an edge to which the terminal section is connected, and
the edges are inclined with respect to the longitudinal direction and oriented towards opposite sides of the contact system.

4. A contact system according to claim 3, wherein
each of the first extension section and the second extension section extends in the longitudinal direction towards each other over a length which is substantially half of the length of the movable contact in the longitudinal direction.

5. A contact system according to claim 1, wherein
the contact system is closed by moving the movable contact into a closed state position at which the first movable contact section is in contact with the first leg of the first stationary contact and the second movable contact section is in contact with the first leg of the second stationary contact.

6. A contact system according to claim 1, wherein
each terminal section is configured as a flat plate oriented parallel to both the alignment direction and the longitudinal direction and provided with a through-hole for connecting to an input or output terminal of an external load.

7. A contact system according to claim 1, wherein
the movable contact is comprised of one or more movable contact elements extending in the longitudinal direction and arranged side by side, each of the one or more movable contact elements comprising a first movable contact section disposed between the first leg and the second leg of the first stationary contact and a second movable contact section disposed between the first leg and the second leg of the second stationary contact, and
each of the first movable contact sections is configured to make contact with the first leg of the first stationary contact and each of the second movable contact sections is configured to make contact with the first leg of the second stationary contact when the contact system is closed.

8. A contact system according to claim 7, wherein
each of the one or more movable contact elements is configured as a flat bar extending in the longitudinal direction; or
each of the one or more movable contact elements is configured as an inverted U-shaped bar having an intermediate section that protrudes, in the closing direction, through a separation region between the first stationary contact and the second stationary contact.

9. A contact system according to claim 8, further comprising
one or more permanent magnets arranged within a space surrounded by the U-shaped intermediate section of the movable contact.

10. A contact system according to claim 1, further comprising:
a support structure for fixing a driving shaft to an intermediate section of the movable contact,
wherein the support structure is configured to support the driving shaft oriented along the closing direction and towards an outside of the contact system.

11. An electromagnetic contactor, comprising:
a contact system including a movable contact configured to move along a closing direction of the contact system, a first stationary contact, and a second stationary contact, the first and second stationary contacts disposed facing each other along a longitudinal direction transverse to the closing direction, wherein each of the first stationary contact and the second stationary contact has a C-shaped body with a first leg and a second leg oriented towards a center of the contact system and spaced apart along the closing direction, wherein the movable contact has a first movable contact section disposed between the first leg and the second leg of the first stationary contact and a second movable contact section disposed between the first leg and the second leg of the second stationary contact, and wherein the first stationary contact and the second stationary contact each comprise a terminal section that extends from the respective second leg towards an alignment direction that forms a non-zero angle with the longitudinal direction of the contact system; and
an electromagnetic driving system configured to operate the contact system to switch between a closed state and an open state.

12. An electromagnetic contactor according to claim 11, wherein
the electromagnetic driving system comprises an electromagnetic coil and a movable magnetic core configured to couple to a driving shaft,
wherein the movable magnetic core is configured to move the driving shaft in the closing direction, when actuated by an electromagnetic actuation force generated by the electromagnetic coil, to move the movable contact towards the first stationary contact and the second stationary contact to close the contact system.

13. An electromagnetic contactor according to claim 12, wherein
the electromagnetic driving system further comprises a return spring coupled to the movable magnetic core on a side opposite to a side coupled to the driving shaft,
wherein the return spring is compressed by the movable magnetic core in the closing direction when the electromagnetic coil is energized to maintain the contact system closed, and
wherein the return spring decompresses and moves the movable magnetic core and the driving shaft in a direction opposite to the closing direction when the electromagnetic coil is de-energized to open the contact system.

14. An electromagnetic contactor according to claim 11, wherein
the electromagnetic contactor is made as an assembly of a first module unit and a second module unit,
the first module unit comprises a first-half housing and the contact system accommodated inside the first-half housing, the first-half housing includes a through-hole for passing a part of the driving shaft coupled to the contact system to outside the first-half housing, and
the second module unit comprises a second-half housing and the electromagnetic driving system accommodated inside the second-half housing, the second-half housing includes a through-hole for inserting the part of the driving shaft protruding from the first-half housing for coupling with the electromagnetic driving system.

15. An electromagnetic contactor according to claim 11, further comprising:
one or more arc chutes arranged in proximity of a contact region between the movable contact and each of the first stationary contact and the second stationary contact.

16. An electromagnetic contactor according to claim 11, wherein
the alignment direction forms a right angle with the longitudinal direction and the closing direction of the contact system, and/or
the terminal section of the first stationary contact is disposed opposite to the terminal section of the second stationary contact with respect to the longitudinal direction of the contact system.

17. An electromagnetic contactor according to claim 11, wherein
the first stationary contact and the second stationary contact each include an intermediate section between the respective first and second legs,
each second leg includes an extension section which extends substantially in parallel to the longitudinal direction towards the center of the contact system and having an edge to which the terminal section is connected, and
the edges are inclined with respect to the longitudinal direction and oriented towards opposite sides of the contact system.

18. An electromagnetic contactor according to claim 11, wherein
the contact system is closed by moving the movable contact into a closed state position at which the first movable contact section is in contact with the first leg of the first stationary contact and the second movable contact section is in contact with the first leg of the second stationary contact.

19. An electromagnetic contactor according to claim 11, wherein
each terminal section is configured as a flat plate oriented parallel to both the alignment direction and the longitudinal direction and provided with a through-hole for connecting to an input or output terminal of an external load.

20. An electromagnetic contactor according to claim 11, wherein
the movable contact is comprised of one or more movable contact elements extending in the longitudinal direction and arranged side by side, each of the one or more movable contact elements comprising a first movable contact section disposed between the first leg and the second leg of the first stationary contact and a second movable contact section disposed between the first leg and the second leg of the second stationary contact, and
each of the first movable contact sections is configured to make contact with the first leg of the first stationary contact and each of the second movable contact sections is configured to make contact with the first leg of the second stationary contact when the contact system is closed.
